(19) United States
(12) Patent Application Publication
(10) Pub. No.: US 2009/0141380 A1
(43) Pub. Date: Jun. 4, 2009

(54) Device for Absorption of a Laser Beam and Device for Attenuating a Laser Beam

(75) Inventors: Detlef Stohr, Castrop-Rauxel (DE); Volker Wirth, Dortmund (DE)

Correspondence Address: LERNER GREENBERG STEMER LLP, P O BOX 2480, HOLLYWOOD, FL, 33022-2480, US

(73) Assignee: LIMO PATENTVERWALTUNG GMBH & CO. KG, Gerstengrund (DE)

(21) Appl. No.: 11/876,255

(22) Filed: Oct. 22, 2007

Related U.S. Application Data
(63) Continuation of application No. PCT/EP2006/003644, filed on Apr. 20, 2006.

(30) Foreign Application Priority Data
Apr. 22, 2005 (DE) DE102005018986.5

(51) Int. Cl. G02B 5/22; G02B 7/00

(52) U.S. Cl. 359/885

(57) ABSTRACT

An apparatus for absorbing a laser beam has an absorption surface on which the laser beam is incident and which absorbs the beam at least partially. The apparatus also has a cooling device for cooling the absorption surface and an optical device, such as in the form of a cylindrical lens, for expanding the laser beam before it is incident on the absorption surface. The apparatus may also have a beam splitter for attenuating a laser beam.

The present invention relates to a device for absorbing a laser beam as claimed in the preamble of claim 1, as well as a device for attenuating a laser beam as claimed in the preamble of claim 9.

Disadvantages of known absorption devices for laser beams and so-called radiation traps, respectively, are the restriction to rotationally symmetric beam cross-sections and comparatively low beam intensities. However, in particular, laser diode bars have linear cross-sections and, at high beam intensities, present conventional radiation traps with major problems.

The problem on which the present invention is based is the creation of devices of the type mentioned initially which are suitable for laser beams with high beam intensities.

According to the invention, this is achieved by devices of the type mentioned initially with the characterizing features of claims 1 and 9. The dependent claims relate to advantageous developments of the invention.

Claim 1 provides for the device still to comprise optical means to expand the laser beam prior to its incidence on the absorption surface. Through expansion of the laser beam, the absorption surface can be used in a more effective manner for the absorption of the laser beam, so that laser beams of higher intensities can be absorbed.

The device may comprise a housing in which the absorption surface is arranged. In this case, it is possible for an elongated hole, through which the laser beam can enter the housing and be incident on the absorption surface, to be arranged in the housing. This elongated hole allows a laser beam with a linear cross-section to enter the absorption device in an effective manner; when the laser beam enters the housing, the line of the linear cross-section can extend in the longitudinal direction of the elongated hole.

Further features and advantages of the present invention will become clear from the following description of preferred exemplary embodiments and with reference to the attached figures, in which

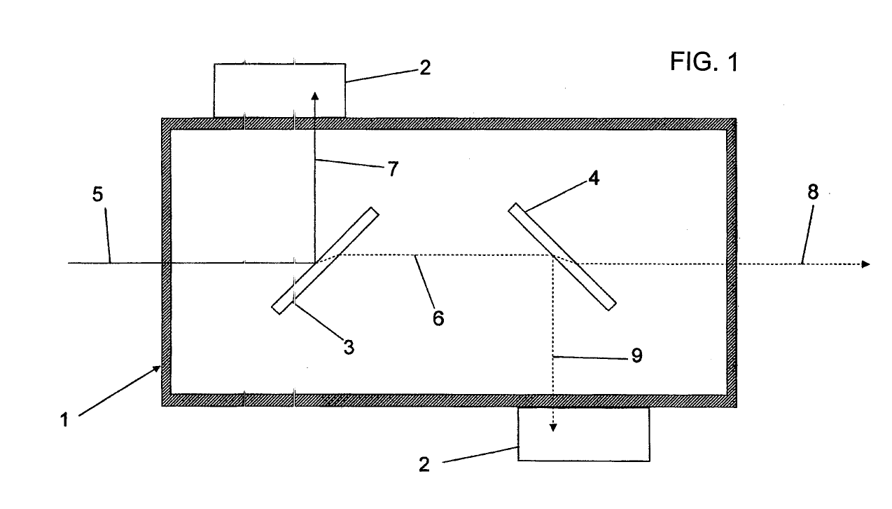

FIG. 1 is a schematic section view of a device according to the invention for attenuating a laser beam;

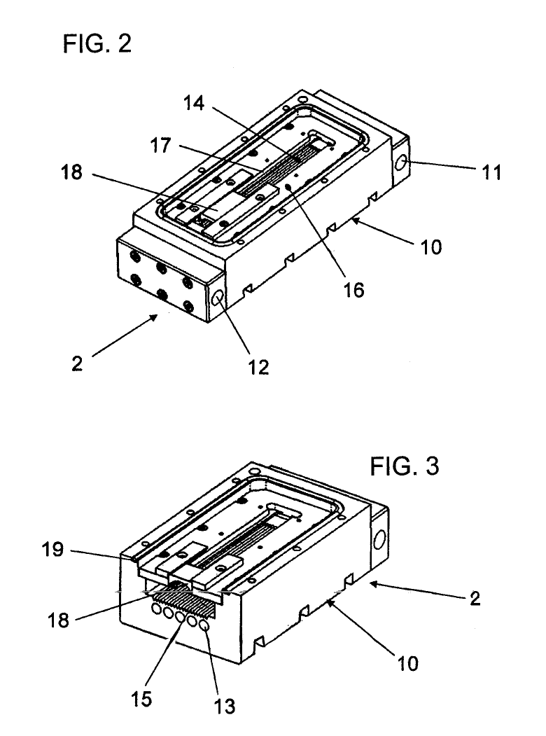

FIG. 2 is a perspective view of a device according to the invention for absorbing a laser beam;

FIG. 3 is a partially sectioned perspective view of the device according to FIG. 2;

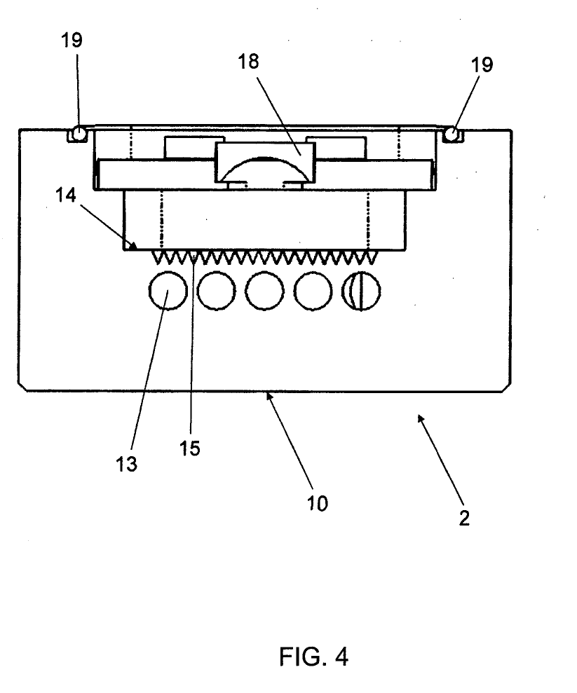

FIG. 4 is a cross-section through the device according to FIG. 2.

The embodiment of a device according to invention for attenuating a laser beam as shown in FIG. 1 comprises a housing 1, to whose exterior two devices 2 according to the invention for absorbing a laser beam are attached. Two beam splitter means 3, 4 are also arranged in the housing 1.

In the illustrated exemplary embodiment, the beam splitter means 3, 4 are in the form of plane-parallel plates, which are provided with a dielectric coating. For example, the coating is in this case chosen in such a way that, in the case of an angle of 45° (see example in FIG. 1) between the plates and the beam direction of the laser beam 5 that is to be attenuated, said beam is total reflected and is diverted as the reflected beam 7 upwards in FIG. 1. This reflected beam 7 enters the first of the devices according to the invention 2 for absorbing a laser beam, and is absorbed there.

If the angle is not equal to 45°, a partial beam 6 passes through the first beam splitter means 3 and is incident on the second beam splitter means 4. Said beam splitter means 4 will preferentially be at an angle corresponding to that of the first splitter means 3 to the laser beam 5 that is to be attenuated, so that the beam offset caused by the plane-parallel plates is compensated for. In particular, the second beam splitter means 4 can be twisted synchronously with the first beam splitter means 3, so that in general the same percentage is reflected and transmitted. The partial beam 9 reflected by the second beam splitter means 4 enters the second of the devices 2 according to the invention for absorbing a laser beam and is likewise absorbed there. The beam 8 which has passed through the second beam splitter means 4 leaves the device according to the invention for attenuating a laser beam as the attenuated beam 8.

FIGS. 2 to 4 show one of the devices 2 according to the invention for absorbing a laser beam, in detail. The device 2 comprises a housing 10 with a coolant entry opening 11 and a coolant exit opening 12. A plurality of coolant channels extend between the coolant entry opening 11 and the coolant exit opening 12. Water, for example, can be used as a coolant.

The housing 10 is elongated and is closed on its top face (as in FIG. 2 and FIG. 3) by a plate 16, which has an elongated hole 17 extending along the longitudinal direction of the housing 10 for a laser beam to pass through. There is a cavity underneath the elongated hole 17, which is bounded at the bottom by an absorption surface 14, which can absorb as much of the laser beam as possible. For this purpose, the absorption surface is black and has a multiplicity of grooves 15, which taper to a point, and which the laser radiation can enter. The grooves 15 extend in the longitudinal direction of the housing 10. It is equally possible for the grooves 15 to extend in the transverse direction of the housing 10.

The elongated hole 17 is longer than it is wide. In particular, the elongated hole can be more than twice as long as it is wide. It is possible for the length of the elongated hole 17 to be three to five times or more than five times as large as the width of the elongated hole 17. For example, the elongated hole 17 can be five to ten times as long as it is wide and, in particular, it may be approximately seven or eight times as long as it is wide. It is also possible for the length of the elongated hole 17 to be more than ten times as large as the width of the elongated hole 17.

The cooling channels 13 run under the absorption surface 14, so that the heat produced by the absorbed laser radiation can be transported away from the absorption surface 14 in this manner.

Optical means 18 can be arranged in the region of the elongated hole 17. In the illustrated exemplary embodiment, the optical means are in the form of a plano-concave cylindrical lens, whose cylinder axis extends in the longitudinal direction of the housing 10 and in the longitudinal direction of the elongated hole 17. With the help of such a cylindrical lens, a laser beam incident on it is expanded in the transverse direction of the housing 10, so that it is distributed over a larger area of the absorption surface 14. In this manner, laser beams with relatively high intensities can be absorbed by the device 2 according to the invention.

In the illustrated exemplary embodiment, the cylindrical lens is arranged only in the front region according to FIG. 2 and FIG. 3 of the elongated hole 17. The reason for this is that, in the arrangement according to FIG. 1, the laser beam to be attenuated 5 is totally reflected only when its beam direction is at an angle of 45° to the plates. At an angle of approximately 45°, the reflected laser beam 7 is incident on the cylindrical lens and is expanded. At smaller angles, only a smaller proportion of the laser beam 5 is reflected, so that the reflected laser beam 7 has a lower—in some cases much lower—intensity. For this reason, the laser beam 7 no longer needs to be expanded for angles much smaller than 45°. For this reason, the extent of cylindrical lens is limited in the longitudinal direction of the housing. It is likewise possible to provide different optical means 18, to lengthen the extent of the cylindrical lens in different arrangements of the device 2, or to arrange it at a different location.

The top face of the housing 10, according to FIG. 2 to FIG. 4, has a circumferential seal 19, which, for example, is in the form of an O-ring located in a grove. This seal 19 allows the device 2 to be attached closely to the device for attenuating a laser beam (in this content, see FIG. 1).

1-11. (canceled)

12. An apparatus for absorbing a laser beam, comprising:
an absorption surface disposed to have the laser beam incident thereon and to at least partly absorb the laser beam;
a cooling device for cooling said absorption surface; and
an optical device for expanding the laser beam before an incidence thereof on said absorption surface.

13. The apparatus of claim 12, wherein said optical device includes at least one lens.

14. The apparatus of claim 13, wherein said at least one lens is cylindrical.

15. The apparatus of claim 12, wherein said cooling device allows said absorption surface to be liquid cooled.

16. The apparatus of claim 12, wherein said absorption surface includes a plurality of grooves in which laser light can be absorbed.

17. The apparatus of claim 12, which further comprises a housing in which said absorption surface is located.

18. The apparatus of claim 17, wherein said housing includes an elongated hole, through which the laser beam can enter said housing and be incident on said absorption surface.

19. The apparatus of claim 18, wherein said at least one lens is cylindrical and has a cylinder axis, said elongated hole has a longitudinal direction, and the cylinder axis extends in the longitudinal direction.

20. An assembly for attenuating a laser beam, comprising, in combination:
at least one beam splitter and an absorption apparatus:
said first beam splitter for deflecting part of the laser beam into said absorption apparatus;
said absorption apparatus including an absorption surface disposed to have the laser beam incident thereon and to at least partly absorb the laser beam, a cooling device for cooling said absorption surface, and an optical device for expanding the laser beam before being incident on said absorption surface.

21. The assembly of claim 20, wherein said absorption apparatus includes a housing formed with an elongated hole through which the laser beam can enter said housing, and wherein said beam splitter is movable to direct the laser beam in a longitudinal direction of said elongated hole.

22. The assembly of claims 20, wherein said beam splitter is one of first and second beam splitters disposed to be moved synchronously.
